(19) United States
(12) Patent Application Publication
(10) Pub. No.: US 2014/0274285 A1
(43) Pub. Date: Sep. 18, 2014

(54) Electronic Gaming Machine and Gaming Method

(71) Applicant: AINSWORTH GAME TECHNOLOGY LIMITED, Newington (AU)

(72) Inventor: Jason Meyer, Abbotsford (AU)

(21) Appl. No.: 13/827,882

(22) Filed: Mar. 14, 2013

(30) Foreign Application Priority Data
Mar. 13, 2013 (AU) 2013900869

(51) Int. Cl. G07F 17/34

(52) U.S. Cl. CPC G07F 17/34
USPC 463/20

(57) ABSTRACT

An electronic gaming machine has an electronic game controller and a display where game symbols are arranged in an array, where R is the number of available predetermined game positions in the array. The electronic game controller determines the appearance of a group of special symbols in the predetermined game positions, the group affecting the outcome of the game, and the probability of the group appearing on the array is less than 1 in X, X being the average number of games played with R predetermined game positions. A gaming method is also provided.

### BACKGROUND

The present invention relates to an electronic gaming machine and a gaming method for an electronic gaming machine, where the electronic gaming machine also includes devices that permit gaming online on the Internet or download and execute computer software to enable gaming on that device. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played. Conventionally, such reel-type games comprise a main or base game offered by the electronic gaming machine.

Bonus or “feature” games may be provided by an electronic gaming machine in addition to the base or main game. Typically feature games use the same set of reels as the main game and are limited to a set of free games operated under a single set of rules that may be slightly modified from the base game. Once the free feature games have been played, the electronic gaming machine resets itself and returns the player back to the base game.

There is always a possibility of the same symbol appearing in each position on each reel or a majority of reels. However, the probability of such an event (also called the “hit rate”) occurring is very low such that it is very rare for such an event to occur even if one were to play the electronic gaming machine for long periods of time.

Consequently, it is difficult to retain player interest because there is no apparent incentive for the player to continue playing the same electronic gaming machine.

It is an object of the present invention to overcome or substantially ameliorate one or more of the disadvantages of prior art, or at least to provide a useful alternative.

It is an object of the invention in at least one preferred form to provide an electronic gaming machine and a method for controlling an electronic gaming machine that encourages player interest.

### SUMMARY

According to a first aspect of the invention, there is provided an electronic gaming machine comprising:

a display for displaying a game comprising game symbols arranged into an array of predetermined game positions, wherein R is the number of available predetermined game positions for play in said game and predetermined winning combinations of randomly selected game symbols in each game award prizes to a player, and

an electronic game controller for controlling the display of said game symbols on said display,

wherein said electronic game controller determines the appearance of a group of special symbols in said predetermined game positions, said group affecting the outcome of said game and S being the number of special symbols in said group, and

wherein the probability of said group appearing on said array is less than 1 in X, X being the average number of games played with said R predetermined game positions.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Preferably, said game is a base game and said predetermined game positions are selectable for play by said player, wherein X is the theoretical average number of games required for the appearance said group to occur when R predetermined game positions are selected for play.

Alternatively or additionally, said game comprises a feature game and a trigger event in a base game activates said feature game for play, said predetermined game positions being selectable for play by said player in said feature game, and wherein X is the theoretical average number of games required for the appearance of said group to occur in said feature game multiplied by the probability of said trigger event occurring in said base game, when R predetermined game positions are selected for play.

Preferably, said predetermined game positions are arranged in rows and/or columns in said array.

Preferably, said special symbols in said group are associated with each other. More preferably, said special symbols comprise at least one or more of game symbols that are visually the same, have a common element, share a common enhancing effect on the outcome of the game, and have an additional function in said game. In one preferred form, said common element comprises an image associated with, or a representation of, said special symbols in said group. In another preferred form, said common element comprises an image associated with, or a representation of, said group. In a further preferred form, said additional function is to act as at least one of a scatter symbol, trigger symbol, substitute symbol and jackpot symbol.

Preferably, at least two special symbols of said group form part of at least one of said predetermined winning combinations of game symbols. Alternatively, at least two special symbols of said group form part of at least two of said predetermined winning combinations of game symbols.

Preferably, X is less than or equal to 10,000. More preferably, X is from 5,000 to 10,000. Even more preferably, X is from 1,000 to 5,000. It is further preferred that X is from 750 to 1,000. It is even further preferred that X is from 500 to 750. Yet more preferably, X is from 250 to 500. In one preferred form, X≦100. In another preferred form, X≦50. In a further preferred form, X≦25.

Preferably, said predetermined game positions are arranged in columns in said array and said group comprises at least two special symbols in at least two different columns.

Preferably, said predetermined game positions are arranged in columns in said array and said group comprises at least two predetermined game positions from two adjacent columns. Alternatively, said predetermined game positions are arranged in columns in said array and said group comprises at least 80% of the predetermined game positions in two adjacent columns. In one preferred form, said predetermined game positions are arranged in columns in said array and said group comprises all the predetermined game positions in two adjacent columns.

Preferably, S=R. Alternatively, 6<S<R. In another alternative, 9<S<R. In yet another alternative, 12<S<R. In a further alternative, S=R−1. In a yet further alternative, S=R−2. In a further alternative, S=R−3. In a further alternative, R>15 and S>9. In a further alternative, S>0.5×R. In a further alternative, S>0.6×R. In a further alternative, S>0.7×R. In a further alternative, S 0.8×R. In a further alternative, S>0.9×R.

Preferably, said group occupies at least ten predetermined game positions adjacent each other starting from the rightmost side of said array. Alternatively, said group occupies at least ten predetermined game positions adjacent each other starting from the rightmost side of said array.

Preferably, said group occupies at least fifteen predetermined game positions adjacent each other starting from the rightmost side of said array. Alternatively, said group occupies at least fifteen predetermined game positions adjacent each other starting from the leftmost side of said array.

Preferably, said group occupies at least the predetermined games positions to the left of a centre line of said array. Alternatively, said group occupies at least the predetermined games positions to the right of a centre line of said array.

Preferably, said special symbol comprises at least one of a top paying game symbol in which a combination of said top paying game symbols confers the highest prize value; a substitute symbols, a symbol equivalent to said substitute symbol or any symbol associated with said substitute symbol, and a reveal symbol that changes, transforms or morphs into any game symbols and at least pays winnings on the resultant symbols.

Preferably, said electronic game controller randomly determines the appearance of said group. More preferably, the trigger event comprises a random event determined by said electronic game controller at the start of play of said game.

Preferably, said group appears in response to a trigger event on said array. In one preferred form, said trigger event comprises the appearance of one or more trigger symbols on said array. In another preferred form, the trigger event comprises an in-game event during play of said game.

Preferably, said game comprises a plurality of additional arrays of game symbols arranged in predetermined game positions and the number of predetermined game positions R is limited to the available predetermined game positions of said array and excludes the predetermined game positions of said additional arrays.

Preferably, said game comprises a sequence of plays of said game and wherein S=R is guaranteed for at least one of said plays that are played during said sequence. In one preferred form, said game comprises a plurality of said sequences such that S=R is guaranteed for at least one of said plays that is played for each of said sequences. In one particularly preferred form, said game comprises a base game and a feature game, said feature game being triggered by a trigger event in said base game and comprising a sequence of plays of said feature game, wherein S=R is guaranteed for at least one of said plays that is played during said sequence for each feature game triggered by said trigger event.

Preferably, said game comprises a sequence of plays of said game and wherein S>0.5×R is guaranteed for at least one of said plays that are played during said sequence. In one preferred form, said game comprises a plurality of said sequences such that S>0.5×R is guaranteed for at least one of said plays that is played for each of said sequences. In one particularly preferred form, said game comprises a base game and a feature game, said feature game being triggered by a trigger event in said base game and comprising a sequence of plays of said feature game, wherein S>0.5×R is guaranteed for at least one of said plays that is played during said sequence for each feature game triggered by said trigger event.

Preferably, said game comprises a jackpot prize. More preferably, said jackpot prize comprises a mystery jackpot. In one preferred form, said game shares said jackpot prize with another game played on said electronic gaming machine. In another preferred form, said game shares said jackpot prize with another game played on a different electronic gaming machine to said electronic gaming machine.

Preferably, said electronic game controller is configured to display a base game and/or a feature game on said display. More preferably, said game comprises said base game. Alternatively, said game comprises said feature game.

Preferably, the game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to said trigger event. Alternatively, said electronic game controller causes the display of said feature game and said base game during play of said base game, said feature game being inactive until triggered. In this preferred form, the change in said feature game from being inactive to active may be indicated on the display.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

According to a second aspect of the invention, there is provided a gaming method for playing an electronic gaming machine comprising a display and an electronic game controller, the method comprising the steps of:

controllably displaying game symbols on said display for playing a game, wherein said game symbols are arranged into an array of predetermined game positions, wherein R is the number of available predetermined game positions for play in said game and predetermined winning combinations of randomly selected game symbols award prizes to a player;

controllably determining the appearance of a group of special symbols on said display, S being the number of special symbols in said group, so that the probability of said group appearing on said array is less than 1 in X, X being the average number of games played with said R predetermined game positions, and

determining any changes to the outcome of said game based on the appearance of said group.

Preferably, said game is a base game and said method further comprises the step of selecting predetermined game positions for play, wherein X is the theoretical average number of games required for the appearance said group to occur when R predetermined game positions are selected for play.

Alternatively or additionally, said game comprises a feature game and said method further comprises the steps of activating said feature game in response to a trigger event in a base game and selecting said predetermined game positions for play in said feature game, wherein X is the theoretical average number of games required for the appearance of said group to occur in said feature game multiplied by the probability of said trigger event occurring in said base game, when R predetermined game positions are selected for play.

Preferably, said method further comprises arranging said predetermined game positions in rows and/or columns in said array.

Preferably, said method further comprises associating said special symbols in said group with each other. More preferably, said associating step comprises providing said special symbols that comprise at least one or more of game symbols that are visually the same, have a common element, share a common enhancing effect on the outcome of the game, and have an additional function in said game. In one preferred form, said associating step comprises associating an image associated with, or providing a representation of, said special symbols in said group. In another preferred form, said associating step comprises associating an image associated with, or providing a representation of, said group. In a further preferred form, said associating step comprises providing said additional function that acts as at least one of a scatter symbol, trigger symbol, substitute symbol and jackpot symbol.

Preferably, said group determining step comprises causing at least two special symbols of said group to form part of at least one of said predetermined winning combinations of game symbols. Alternatively, said group determining step comprises causing at least two special symbols of said group to form part of at least two of said predetermined winning combinations of game symbols.

Preferably, said method further comprises making X≦10,000. More preferably, said method further comprises making X is from 5,000 to 10,000. Even more preferably, said method further comprises making X is from 1,000 to 5,000. It is further preferred that said method further comprises making X is from 750 to 5,000. It is even further preferred that said method further comprises making X is from 500 to 750. Yet more preferably, said method further comprises making X is from 250 to 500. In one preferred form, said method further comprises making X≦100. In another preferred form, said method further comprises making X≦50. In a further preferred form, said method further comprises making X≦25.

Preferably, said method further comprises arranging said predetermined game positions in columns in said array, and said group determining step comprises causing at least two special symbols to appear in at least two different columns.

Preferably, said method further comprises arranging said predetermined game positions in columns in said array, and said group determining step comprises causing two special symbols to appear in at least two predetermined game positions from two adjacent columns. Alternatively, said method further comprises arranging said predetermined game positions in columns in said array, and said group determining step comprises causing special symbols to appear in at least 80% of the predetermined game positions in two adjacent columns. In one preferred form, said method further comprises arranging said predetermined game positions in columns in said array, and said group determining step comprises causing special symbols to appear in all the predetermined game positions in two adjacent columns.

Preferably, said group determining step comprises causing the appearance of said group such that S=R. Alternatively, said group determining step comprises causing the appearance of said group such that 6<S<R. In a further alternative, said group determining step comprises causing the appearance of said group such that 9<S<R. In yet another alternative, said group determining step comprises causing the appearance of said group such that 12<S<R. In another alternative, said group determining step comprises causing the appearance of said group such that S=R−1. In a further alternative, said group determining step comprises causing the appearance of said group such that S=R−2. In a further alternative, said group determining step comprises causing the appearance of said group such that S=R−3. In a further alternative, said group determining step comprises causing the appearance of said group such that R>15 and S>9. In a further alternative, said group determining step comprises causing the appearance of said group such that S>0.5×R. In a further alternative, said group determining step comprises causing the appearance of said group such that S≧0.6×R. In a further alternative, said group determining step comprises causing the appearance of said group such that S≧0.7×R. In a further alternative, said group determining step comprises causing the appearance of said group such that S≧0.8×R. In a further alternative, said group determining step comprises causing the appearance of said group such that S≧0.9×R.

Preferably, said group determining step further comprises causing special symbols to appear in at least ten predetermined game positions adjacent each other starting from the rightmost side of said array. Alternatively, said group determining step further comprises causing special symbols to appear in at least ten predetermined game positions adjacent each other starting from the rightmost side of said array.

Preferably, said group determining step further comprises causing special symbols to appear in at least fifteen predetermined game positions adjacent each other starting from the rightmost side of said array. Alternatively, said group determining step further comprises causing special symbols to appear in at least fifteen predetermined game positions adjacent each other starting from the leftmost side of said array.

Preferably, said group determining step further comprises causing special symbols to appear in at least the predetermined games positions to the left of a centre line of said array.

Preferably, said group determining step further comprises causing special symbols to appear in at least the predetermined games positions to the right of a centre line of said array.

Preferably, said method further comprises providing a plurality of additional arrays of game symbols arranged in predetermined game positions on said display and restricting R to the available predetermined game positions of said array and excluding the predetermined game positions of said additional arrays.

Preferably, said method further comprises providing a sequence of plays of said game and guaranteeing S=R for at least one of said plays that are played during said sequence. In one preferred form, said sequence providing step comprises providing a plurality of said sequences and said guaranteeing step comprises guaranteeing S=R for at least one of said plays that is played for each of said sequences. In one particularly preferred form, said game comprises a base game and a feature game, said method further comprising triggering said feature game in response to a trigger event in said base game, providing a sequence of plays of said feature game and guaranteeing S=R for at least one of said plays that is played during said sequence for each feature game triggered by said trigger event.

Preferably, said method further comprises providing a sequence of plays of said game and guaranteeing S>0.5×R for at least one of said plays that are played during said sequence. In one preferred form, said sequence providing step comprises providing a plurality of said sequences and said guaranteeing step comprises guaranteeing S>0.5×R for at least one of said plays that is played for each of said sequences. In one particularly preferred form, said game comprises a base game and a feature game, said method further comprising triggering said feature game in response to a trigger event in said base game, providing a sequence of plays of said feature game and guaranteeing S>0.5×R for at least one of said plays that is played during said sequence for each feature game triggered by said trigger event.

The method also preferably has the preferred features of the first aspect of the invention stated above, where applicable.

According to a third aspect of the invention, there is provided a computer system comprising a central processing unit configured for communication with an electronic gaming machine, wherein said computer system is configured to perform the method of the second aspect of the invention.

According to a fourth aspect of the invention, there is provided a computer program configured to perform the method of the second aspect of the invention.

According to a fifth aspect of the invention, there is provided a non-transitive carrier medium carrying computer executable code that, when executed on a central processing unit configured for communication with an electronic gaming machine, causes the central processing unit to perform the method of the second aspect of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1;

FIG. 3 is a schematic drawing illustrating a game displayed on an array of the electronic gaming machine of FIG. 1;

FIG. 4 is a schematic drawing illustrating a change to the game of FIG. 3;

FIG. 5 is a schematic drawing illustrating a game displayed on an array of the electronic gaming machine according to another embodiment of the invention;

FIG. 6 is a schematic drawing illustrating a game displayed on an array of the electronic gaming machine according to yet another embodiment of the invention;

FIG. 7 is a schematic drawing illustrating a game displayed on an array of the electronic gaming machine according to a further embodiment of the invention;

FIG. 8 is a schematic drawing illustrating a game displayed on an array of the electronic gaming machine according to a still further embodiment of the invention;

FIG. 9 is a schematic drawing illustrating a game displayed on an array of the electronic gaming machine according to another embodiment of the invention;

FIGS. 10 and 11 are schematic drawings illustrating other possible changes to the game according to further embodiments of the invention;

FIG. 12 is a schematic drawing illustrating a game displayed on an array of the electronic gaming machine according to a further embodiment of the invention; and

FIG. 13 is a schematic drawing illustrating a change to the game of FIG. 12.

### DETAILED DESCRIPTION OF THE VARIOUS EMBODIMENTS

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. The electronic game controller 4 is generally in the form of a central processing unit, such as a computer, and is in electronic communication with a display in the form of a video display screen 7, as well as various input devices on the console 3, as best shown in FIG. 2. It is also appreciated that a person skilled in the art would readily understand the location and use of the electronic game controller 4 in the electronic gaming machine 1.

The video screen 7 may also display other standard game information (not shown), including the number of pay lines available, the number of player-selected pay lines, the amount of credits per line, the amount of player credits the amount of the current bet wagered by the player, the amount of wins by the player, a message area, a general menu button and a current denomination button indicating the currently selected base bet denomination.

The electronic game controller 4 is programmed to provide a game 8 on the electronic gaming machine 1 for play by a player, as best shown in FIG. 1. The game 8 has game symbols 9 arranged into an array 10 in the form of five columns or “reels” 11, as best shown in FIG. 3. While the array 10 is arranged with five columns or “reels” 11 and an even number of rows, it will be appreciated by one skilled in the art that other arrays could be used, such as the industry standard 5×3 or 3×3, 4×3, 5×5, 4×4, etc. Also, the array 10 can have an uneven number of rows and/or columns.

The array 10 of the game 8 defines 15 predetermined game positions in the form of “squares” or cells 12, in which the game symbols 9 appear. The array 10 is arranged so that a player can select one or more predetermined “pay lines” 13 defined around the array, which correspond to combinations of the game positions 12. The pay lines 13 correspond to the lines selected by the player and generally comprise at least one game position 12 from each reel 11. The number of pay lines 13 that can be selected by the player depends on the amount of the monetary bet for playing a game on the array 10. In this embodiment, each of the cells 12 is available for play in the game 8.

The game symbols 9 can include a mixture of picture symbols (such as animal symbols, playing card symbols, scatter symbols, wild card symbols and trigger symbols to trigger a feature game (if any)). The electronic game controller 4 randomly determines the appearance of the game symbols 9 on the array 10.

The player initially makes a bet using vending slots 5 initiate play of the electronic gaming machine 1 to build up credit to play any of the selectable games on the electronic gaming machine. For example, the player can bet or wager monetary amounts equivalent to a particular amount of credits, depending on the bet denomination selected for the game 8. Also, the player can make any additional side bets or ante-bets during play of the game 8 once the game has commenced to access additional features in the game, such as increasing the number of winning combinations in the game.

The electronic game controller 4 then causes the reels 11 to appear to visibly rotate or “spin”, and randomly display the game symbols 9 in each cell 12. The electronic game controller 4 also randomly determines the appearance of a group 15 of two or more special symbols 16 in two or more of the cells 12, as best shown in FIG. 4. The group 15 affects the outcome of the game 8 by increasing the chances of obtaining a winning combination of game symbols 9 and/or the value of the winning combinations. The special symbols may act as a substitute symbol (i.e., a wild card), scatter symbol, jackpot symbol or confer a variety of game enhancing elements, such as free games or a bonus prize.

The electronic game controller 4 controls the probability of the group 15 appearing on the array 10 so that it is less than 1 in X, where X is the average number of games played with the 15 cells 12. Thus, while there is some randomness in the appearance of the group 15, it is within the predetermined probability parameters. The electronic game controller 4 ensures that the probability is kept within the required parameters by adjusting the reel strip or switching to a reel strip having a greater probability of the TriggerS symbol 17 appearing where the appearance of the group 15 of special symbols 16 has not occurred for a predetermined number of plays of the game. By setting this probability, the electronic game controller 4 controls the frequency of group 15 appearing on the array 10 and thus adjusts the volatility of the electronic gaming machine 1.

The average number of games X can be predetermined by the electronic game controller and is selected so that there is a comparatively greater likelihood of the group 15 appearing than typically expected by the player on a standard or conventional electronic gaming machine. For example, it is preferred that X is at least 10,000, and more preferably from 5,000 to 10,000, even more preferably 1,000 to 5,000. However, in particularly preferred forms, it is preferred that X is from 750 to 1,000, from 500 to 750, from 250 to 500 to ensure that the player observes the group 15 1 of special symbols 16 over a period of time. In other preferred forms, X≦100, X≦50 or X≦25 ensure that the player observes the group of special symbols in a single playing session. By way of contrast, a conventional electronic gaming machine with stacked game symbols (i.e., the same game symbol on each position so that they are “stacked” together) on its reel strips typically has about 90 game symbols on each reel strip. This means that for an array of the same size (i.e., fifteen cells 12 in the array 10), the probability of each of the game symbols appearing in each of the fifteen cells would be 1 in 90⁵ (i.e., 1 in 5,904,900,000) for each combination of game symbols being the same that takes up 50% of the array. Similarly, the probability of more than 50% of the game symbols in the array being the same would be the as above, multiplied by the number of possible combinations of game symbols that would meet the requirement that 50% of the game symbols are the same. For example, even if there were 1,000 such possible combinations based on the layout of symbols on each reel strip, the probability would be calculated to be 1 in 5,904,900 games on average to trigger the required number of same symbols. In either case, the probability of such an event occurring on a conventional electronic gaming machine is significantly low compared to the probabilities listed above of the group 15 of special symbols 16 that appear on the array 10, which are at least 1 in 10,000 and as high as 1 in 25.

In this embodiment, the group 15 appears in response to the appearance of one or more trigger “TriggerS” symbols 17 on the display 7, as best shown in FIG. 3. Thus, after the reels 11 stop spinning, the electronic game controller 4 determines whether there are any TriggerS symbols 17 on the array 10. If not, then the electronic game controller 4 determines whether there are any predetermined winning combinations of the game symbols 9 appear in any player-selected pay lines 13, such as “three of a kind”, “four of a kind” and “five of a kind” and/or other combinations of a “full house”, “straight” or “flush” where the game symbols represent playing cards. It will be appreciated that other winning combinations of game symbols 9 can also be provided. If so, the electronic game gaming machine 1 enters a winning game state and awards a prize according to the displayed predetermined winning combination(s).

Where the TriggerS symbol 17 appears on the array 10, the group 15 of special symbols 16 appear, as best shown in FIG. 4. The group 15 comprises all the symbols 9 in the reels 11a, 11b and 11c, including the TriggerS symbol 17. The electronic game controller 4 then determines whether winning combinations of game symbols occur on player-selected pay lines 13 based on the effect of the special symbols 16. In this embodiment, the special symbols 16 act as substitute symbols. In this case, the electronic game controller 4 has made the group 15 comprise 9 special symbols 16, taking up 60% of the available cells 12 in the array 10. It is preferable to have at least more than 6 special symbols 16 in the group 15 as it is sufficiently large to indicate to the player that the group has appeared on the array 10.

Thus, by increasing the “hit” rate of the group 15 of special symbols 16 to fill several or potentially all of the cells 12 in the array 10, a player is more likely to likely to see the array filled or almost filled by the same symbols, thus increasing the chances of a large or significant win and retaining the player's interest in playing the same electronic gaming machine. Also, it can be seen that the player's interest and excitement in the game 8 will be enhanced once the TriggerS symbol 17 appears as he or she will anticipate the appearance of the group 15 of special symbols 16 that is likely to increase the chances of obtaining a winning combination on the array 10 and/or enhance the value of any such winning combination.

Another embodiment of the invention is illustrated in FIG. 5, where corresponding features have been given the same reference numerals. In this embodiment, the appearance of the TriggerS symbol 17 on the array 10 as illustrated in FIG. 3 causes the appearance of the group 15 so that it occupies all four reels 11a, 11b, 11c and 11d from the left hand side of the array 10, as best shown in FIG. 5. In addition, where the scatter symbol 9a is part of the group 15, the special symbol becomes a hybrid special symbol 18 that retains the function of the scatter symbol. This may be done by providing a hybrid version of the special symbol 9b. The hybrid special symbol 18 indicates that it functions or acts as both the special symbol 16 and as a scatter symbol 9a. In this case, the hybrid special symbol 18 has the word “scatter” appear with the word “special” to indicate its dual function. However, it will be appreciated that other indicators can be used, including images or representations associated with the scatter symbol 9a to indicate its additional function as a scatter symbol.

A further embodiment of the invention is illustrated in FIG. 6, where corresponding features have been given the same reference numerals. This embodiment also relies on the appearance of the TriggerS symbol 17 to trigger the appearance of the group 15 of special symbols 16. In this embodiment, the group 15 is equal to the entire array 10; that is, the special symbols 16 fill up all 15 cells 12 in the array 10. This is equivalent to a maximum winning combination for any player-selected pay line 13. Also, as a scatter symbol 9a initially appeared on the array 10, its cell 12 has the hybrid special symbol 18 to indicate its dual function as a special symbol and as a scatter symbol. Also, there is no hybrid version of the special symbol 16 in the cell 12 that had the substitute WILD symbol 9b as in this embodiment, the special symbols 16 act as substitute symbols. If the special symbols 16 have a different function, such as offering a bonus prize, there would be a hybrid version of the special symbol to indicate its dual function as both a bonus prize and as a substitute symbol.

Yet another embodiment of the invention is illustrated in FIG. 7, where corresponding features have been given the same reference numerals. In this embodiment, unlike the others, there is no TriggerS symbol 17 to activate the appearance of the group 15 of special symbols 16 on the array 10. Instead, the electronic game controller randomly determines whether the group 15 should appear on the array 10 and, if so, the number of special symbols 16 in the group and where the special symbols 16 are located on the array. In this instance, the electronic game controller 4 has the group 15 appear in reels 11a, 11b, 11d and 11e, omitting central reel 11c, effectively 80% of the available cells 12 in the array 10. Also, the substitute symbol 9b effectively becomes a special symbol due to its substitute function, meaning that there are special symbols 16 that take up all but two of the available cells 12 in the array 10.

Another embodiment of the invention is illustrated in FIG. 8, where corresponding features have been given the same reference numerals. This embodiment is similar to the embodiment of FIG. 7 in that there is no TriggerS symbol 17 to activate the appearance of the group 15 of special symbols 16 on the array 10. Instead, the electronic game controller randomly determines whether the group 15 should appear on the array 10 as described above. In this case, the group 15 comprises all but two of the available cells 12 in the array 10. However, the substitute symbol 9b effectively becomes a special symbol due to its substitute function, so that there are special symbols 16 in all but one of the available cells 12 in the array 10.

Another embodiment of the invention is illustrated in FIGS. 9 to 11, where corresponding features have been given the same reference numerals. In this embodiment a TriggerSP symbol 20 appears in the array 10, as best shown in FIG. 9. The TriggerSP symbol 20 triggers the appearance of both the group 15 of special symbols 16 in at least reels 11a and 11c, and substitute symbols 9b in at least reels 11b and 11d. See FIG. 10. The function of the TriggerSP symbol 20 would be explained in the game rules, including the identifying the reels 11 in which the special symbols 16 and the substitute symbols 9b appear on the array 10. The group 15 fills in twelve of the fifteen available cells 12 in the array, with six of the special symbols 16 being in reels 11a and 11c. As the substitute symbols 9b act as a wild card, they also act as special symbols and are counted as such by the electronic game controller 4. Also, as a scatter symbol 9a initially appeared in reel 11d, it becomes a hybrid special symbol 25 that acts as a substitute symbol and a scatter symbol, as well as a special symbol, thus having triple functionality. Thus, the special symbols 16 in the array 10 are connected or associated by a common element (being their shared function as a special symbol) even if they are each not the exact same game symbol.

FIG. 11 illustrates another possible group 15 that may appear as a result of the TriggerSP symbol 20 appearing in the array of FIG. 9. In this case, all the cells 12 available in the array 10 are selected to show the group 15 of special symbols 16. The group 15 comprises each of the cells 12 from reels 11a, 11c and 11e, displayed as special symbols 16, the cells 12 from reels 11b and 11d displaying substitute symbols 9b that act as special symbols and one cell 12 from the reel 11d where the hybrid special symbol 25 having triple functionality appears.

Another embodiment of the invention is illustrated in FIGS. 12 and 13, where corresponding features have been given the same reference numerals. This embodiment also uses a TriggerSP symbol 20 as described in relation to FIGS. 9 to 11 above. In this case, the array 10 is an extended array that has eighteen available cells 12, where the reels 11c, 11d and 11e have an additional cell compared to the remaining reels 11a and 11b, as best shown in FIG. 12. Again, the TriggerSP symbol 20 has caused the group 15 of special symbols 16 to be located in each of the cells 12 of reels 11a, 11c and 11e, while substitute symbols 9a appear in the cells of reels 11b and 11d also act as special symbols. See FIG. 13. This means that the special symbols fill the entire array 10, as in FIG. 11. Similarly, the group 15 also includes two hybrid special symbols; the hybrid special symbol 18 that has a dual function of being a scatter symbol (in addition to being a special symbol) and the hybrid special symbol 25 that has a triple function of being a scatter and substitute symbol (in addition to being a special symbol).

It will be appreciated that while the preferred embodiments have described the group 15 as taking up all the cells 12 in each reel 11, in other preferred forms the group 15 need only take up or fill a certain percentage of the available cells 12 in the array 10. To provide a discernible advantage to the player the group should occupy at least more than 50% of the available cells 12 in the array 10 (as best shown in FIG. 10). In particularly preferred forms, the group 15 fills in at least 60% (as best shown in FIGS. 4, 11 and 12), 80% (as best shown in FIG. 5), 90% (as best shown in FIG. 8) or all of the available cells 12 in the array 10 (as best shown in FIG. 6). Also, the group 15 can be selected such that the number S of special symbols 16 is related to the number R of available cells 12 in the array. For example, the group can be selected so that S=R (i.e., all available cells 12 in the array 10, as in FIG. 6), S=R−1 (as best shown in FIG. 8), S=R−2 and S=R−3 (as best shown in FIGS. 5 and 7). Furthermore, the group 15 can be selected such that the number S of special symbols 16 is a minimum number. For example, the group 15 can be selected such that 6<S<R (as best shown in FIG. 10) or S>9 where R>15 (as best shown in FIG. 13).

In the preferred embodiments of the invention, the aim is for the group 15 to be displayed so that each play of the game results in an outcome displaying a plurality of the same, equivalent or associated special symbols in a majority of available cells 12 such that the said special symbols 16 are aligned in winning patterns and combinations. There are many ways to achieve this result, some of which include, but are not limited to, the following;
(a) the game 8 provides reel strips heavily loaded with the special symbols 16 in at least one of a base game and a feature game;
(b) the game 8 comprises a trigger event that causes or triggers a large number of (or all of) the available cells 12 to display the group 15 of special symbols 16;
(c) the game 8 comprises a trigger event that causes or triggers a large number of (or all of) the game symbols 9 displayed on the array 10 to change, transform or morph into the special symbols 16;
(d) the game 8 comprises a feature game wherein it is guaranteed a large number of (or all of) the available cells 12 will display the special symbols 16 at least once during play of the feature game each time the feature game is triggered, and
(e) the game 8 provides a feature game wherein the probability of triggering the appearance of a group 15 that comprises a large number of (or all of) the available cells 12 to display the special symbols 16 is increased in comparison the probability of the same event occurring in the base game.

In other preferred forms, the game 8 comprises a base game and a feature game where the feature game provides a sequence of plays of the feature game that are typically free. In this case the feature game is activated or triggered by a trigger event during play of the base game, and in the feature game it is guaranteed that S=R for at least one play of the feature game played during that sequence of plays each time the feature game is activated or triggered. Likewise, in another preferred form, it is guaranteed that S>0.5×R for at least one play of the feature game played during that sequence of plays each time the feature game is activated or triggered.

Also, while the preferred embodiments have described that the available cells 12 of the array 10 equal all the cells shown on the array, it will be appreciated that in other preferred forms, a number of the cells are not available for play during the game. For example, depending on the amount of the bet wagered by the player, he or she may only be able to access three of the reels 11 making only nine cells 12 being available for play. Only by making a further ante-bet, the player can access one or more the remaining reels (and hence cells). In this case, only the “active” or available cells 12 will be use in determining the probability of the group 15 appearing during play of the game.

In other preferred forms, the special symbol 16 is selected from one of the game symbols 9 other than acting as a substitute symbol 9a. For example, the special symbol 16 can be a “top paying” game symbol (i.e., one in which a combination of those symbols confers the highest prize value). Alternatively, the special symbol 16 is a new symbol, such as a reveal symbol that changes, transforms or morphs into any game symbols and at least pays winnings on the resultant symbols.

In a further preferred form, the group 15 comprises different types of special symbols 16, but the special symbols in the group are associated with each other. This can be achieved by having special symbols comprise at least one or more of game symbols that are visually the same, have a common element, share a common enhancing effect on the outcome of the game, and have an additional function in said game. In one variation, the common element comprises an image associated with, or a representation of, said special symbols in said group. For example, an image corresponding to the image of the substitute symbol or the word “WILD” can be added to a symbol associated with the substitute symbol to indicate their association as special symbols in the same group. Thus, the group 15 can comprise substitute symbols 9b, symbols equivalent to the substitute symbol or any symbol associated with the substitute symbol.

In another variation, the common element comprises an image associated with, or a representation of, said group. For example, the group 15 can comprise symbols that have different images, but each have the word “SUPER” or an image like a star to indicate that they belong to the same group, where the “SUPER” word or star image is not present in any of the game symbols 9.

In other embodiments, the group 15 can be a predetermined set of cells 12 in the array 10. For example, the group 15 can be the at least ten adjacent cells 12 that fill the cells in the reels 11 from the left most reel 11a of the array 10. Alternatively, the group 15 can be the at least ten adjacent cells 12 that fill the cells in the reels 11 from the right most reel 11e of the array 10. In another example, the group 15 can be the at least fifteen adjacent cells 12 that fill the cells in the reels 11 from the left most reel 11a of the array 10. Alternatively, the group 15 can be the at least fifteen adjacent cells 12 that fill the cells in the reels 11 from the right most reel 11e of the array 10.

In the preferred embodiments described above, the cells 12 in which the TriggerS symbol 18 and the TriggerSP symbol 20 appear are chosen to be part of the group 15 of special symbols 16. However, it will be appreciated that in other embodiments the cells 12 in which TriggerS symbol 18 and the TriggerSP symbol 20 do not form part of the group 15 of special symbols 16.

In another preferred form, the individual cells 12 each represent a single “reel” so that the 5×3 array 10 in FIG. 3 has 15 separate reels instead of 5 reels. In this case, the invention would function in the same way, with the electronic game controller 4 selecting reels instead of cells 12 for the group 15 of special symbols 16 appear on the array 10.

In a further preferred form, the electronic game controller 4 determines winning combinations of the game symbols 9 at the conclusion of the spin of the reels 11 before determining whether the appearance of the group 15 on the array 10. In this embodiment, the player is given a second chance to obtain winning combinations of game symbols for a single spin of the reels 11. This embodiment adds to the player's excitement and thus retains his or her interest in playing the game 8 on the electronic gaming machine 1.

In yet another preferred form, the electronic game controller 4 does not wait for all the reels to stop spinning before making a determination as to the appearance of the group 15 of special symbol 16. Instead, the electronic game controller 4 initiates selection of the group 15 before the reels 11 stop spinning. This preferred form can heighten the player's anticipation while waiting for the reels 11 to stop spinning.

It will also be appreciated that the invention may be applied to either a main or “base” game or a feature game offered on the electronic gaming machine. Alternatively, the invention can be applied to both the base game and a feature game. In this case, the electronic game controller 4 controls the display so that during play of the base game on the array and in response to a trigger event, the electronic game controller 4 causes a feature game (not shown) to be displayed on the array. In one embodiment, the use of the TriggerS symbol 17, Trigger SP symbol 20 and/or the group 15 of special symbols 16 can be an additional feature of the base game that is accessible upon the player can making an additional side bet or ante-bet during play of the game 8.

The feature game may employ the same array as the base game, as well as the same game symbols 9 that are used in the base game. However, it will be appreciated that the array for the feature game may vary from the base game. For example, the feature game could adopt a different format of cells and/or use an entirely different set of game symbols, or a mixture of game symbols from the base game and different game symbols.

Where the feature game adopts a reel-type format as illustrated in FIGS. 3 to 13, it typically comprises a predetermined number of free plays or spins of the reels 11. That is, the reels 11 in the feature game are spun without requiring the player to make a bet, unlike the base game. The number of free spins remaining in the feature game is typically indicated on the screen 7 by a suitable counter (not shown). In the feature game, predetermined winning combinations of randomly selected game symbols 9 result in the award of prizes to the player, usually of an enhanced value compared to the prizes awarded in the base game.

The video display screen 7 may also include a top screen, either as a separate display or integrated into the display screen 7, which provides jackpot information in the form of a major jackpot information box and a minor jackpot information box. The top screen ensures that the jackpot information is available to the player at all times during play of the electronic gaming machine 1.

In other preferred forms, the game 8 has other features like jackpot prizes. The jackpot prize can be shared with any other games offered on the electronic gaming machine (as in multi-game gaming machined) or games offered on separate electronic gaming machines. Information relating to the jackpot prize(s) can be provided on the screen 7 or via a top screen that is devoted to displaying jackpot information. In one preferred form, the jackpot prize comprises a mystery jackpot. That is, none of the symbols in the game trigger the jackpot; hence the triggering event is a “mystery”. By way of comparison, a standard jackpot is typically symbol driven in that a particular combination of symbols must occur in the game to trigger the standard jackpot.

Also, in a further preferred form, the player can selectively stop spinning of the reels 11 to increase player interaction. Furthermore, the player can start spinning of the reels 11 to further enhance player interaction.

In the preferred embodiments, the video display screen 7 is a touch screen for use in addition to the player-actuatable buttons 6. This enables the player to select various features, such as responding to any messages or requests issued on the electronic gaming machine 1 by the electronic game controller 4. In this case, the player may control when the reels 11 start spinning and stop spinning in any of the games 8 by simply touching the relevant reel 11.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a computer system configured comprising a central processing unit configured for communication with an electronic gaming machine to perform the invention. In a yet another aspect, the invention includes a non-transitive carrier medium carrying computer executable code that, when executed on a central processing unit configured for communication with an electronic gaming machine, causes said central processing unit to perform the invention. In this case, the non-transitive carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the use of the special symbols 15 and 16 can be a side or ante-bet feature of a base game can be combined with the provision of a separate feature game.

By providing a group of special symbols that fill most or all of the array and a significantly higher hit rate or probability of occurring during game play, players are more likely to see the array filled or almost filled by the same symbols, thus increasing the chances of a large win and thus retains the player's interest and encourages the player to continue playing the various games on the same electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying a game comprising game symbols arranged into an array of predetermined game positions, wherein R is the number of available predetermined game positions for play in said game and predetermined winning combinations of randomly selected game symbols in each game award prizes to a player, and
an electronic game controller for controlling the display of said game symbols on said display,
wherein said electronic game controller determines the appearance of a group of special symbols in said predetermined game positions, said group affecting the outcome of said game and S being the number of special symbols in said group, and wherein the probability of said group appearing on said array is less than 1 in X, X being the average number of games played with said R predetermined game positions.

2. The electronic gaming machine of claim 1, wherein said game is a base game and said predetermined game positions are selectable for play by said player, wherein X is the theoretical average number of games required for the appearance said group to occur when R predetermined game positions are selected for play.

3. The electronic gaming machine of claim 1, wherein said game comprises a feature game and a trigger event in a base game activates said feature game for play, said predetermined game positions being selectable for play by said player in said feature game, and wherein X is the theoretical average number of games required for the appearance of said group to occur in said feature game multiplied by the probability of said trigger event occurring in said base game, when R predetermined game positions are selected for play.

4. The electronic gaming machine of claim 1, wherein said predetermined game positions are arranged in rows and/or columns in said array.

5. The electronic gaming machine of claim 1, wherein said special symbols in said group are associated with each other.

6. The electronic gaming machine of claim 5, wherein said special symbols comprise at least one or more of game symbols that are visually the same, have a common element, share a common enhancing effect on the outcome of the game, and have an additional function in said game.

7. The electronic gaming machine of claim 6, wherein said common element comprises an image associated with, or a representation of, said special symbols in said group.

8. The electronic gaming machine of claim 6, wherein said common element comprises an image associated with, or a representation of, said group.

9. The electronic gaming machine of claim 6, wherein said additional function is to act as at least one of a scatter symbol, trigger symbol, substitute symbol and jackpot symbol.

10. The electronic gaming machine of claim 1, wherein at least two special symbols of said group form part of at least one of said predetermined winning combinations of game symbols.

11. The electronic gaming machine of claim 1, wherein at least two special symbols of said group form part of at least two of said predetermined winning combinations of game symbols.

12. The electronic gaming machine of claim 1, wherein X is between 25 and 10,000, inclusive.

13. The electronic gaming machine of claim 1, wherein S is at least one of:
(a) S=R;
(b) 6<S<R;
(c) 9<S<R;
(d) 12<S<R;
(e) S=R−1;
(f) S=R−2;
(g) S=R−3;
(h) S>9 when R>15;
(i) S>0.5×R;
(j) S≧0.6×R;
(k) S≧0.7×R;
(l) S≧0.8×R, and
(m) S≧0.9×R.

14. The electronic gaming machine of claim 1, wherein said group comprises at least ten to fifteen predetermined game positions adjacent each other starting from the leftmost side of said array.

15. The electronic gaming machine of claim 1, wherein said group occupies at least ten to fifteen predetermined game positions adjacent each other starting from the rightmost side of said array.

16. The electronic gaming machine of claim 1, wherein said group occupies at least the predetermined games positions to the left of a centre line of said array.

17. The electronic gaming machine of claim 1, wherein said group occupies at least the predetermined games positions to the right of a centre line of said array.

18. The electronic gaming machine of claim 1, wherein said game comprises a base game and a feature game, said feature game being triggered by a trigger event in said base game and comprising a sequence of plays of said feature game, wherein at least one of S>0.5×R and S=R is guaranteed for at least one of said plays that is played during said sequence for each feature game triggered by said trigger event.

19. The electronic gaming machine of claim 1, wherein said special symbol comprises at least one of:
(a) a top paying game symbol in which a combination of said top paying game symbols confers the highest prize value;
(b) a substitute symbols, a symbol equivalent to said substitute symbol or any symbol associated with said substitute symbol, and
(c) a reveal symbol that changes, transforms or morphs into any game symbols and at least pays winnings on the resultant symbols.

20. The electronic gaming machine of claim 1, wherein said game comprises a plurality of additional arrays of game symbols arranged in predetermined game positions and the number of predetermined game positions R is limited to the available predetermined game positions of said array and excludes the predetermined game positions of said additional arrays.

21. A gaming method for playing an electronic gaming machine comprising a display and an electronic game controller, the method comprising the steps of:
controllably displaying game symbols on said display for playing a game, wherein said game symbols are arranged into an array of predetermined game positions, wherein R is the number of available predetermined game positions for play in said game and predetermined winning combinations of randomly selected game symbols award prizes to a player;
controllably determining the appearance of a group of special symbols on said display, S being the number of special symbols in said group, so that the probability of said group appearing on said array is less than 1 in X, X being the average number of games played with said R predetermined game positions, and
determining any changes to the outcome of said game based on the appearance of said group.

22. The gaming method of claim 21, wherein said game is a base game and said method further comprises the step of selecting predetermined game positions for play, wherein X is the theoretical average number of games required for the appearance said group to occur when R predetermined game positions are selected for play.

23. The gaming method of claim 21, wherein said game comprises a feature game and said method further comprises the steps of activating said feature game in response to a trigger event in a base game and selecting said predetermined game positions for play in said feature game, wherein X is the theoretical average number of games required for the appearance of said group to occur in said feature game multiplied by the probability of said trigger event occurring in said base game, when R predetermined game positions are selected for play.

24. The gaming method of claim 21, wherein said method further comprises arranging said predetermined game positions in rows and/or columns in said array.

25. The gaming method of claim 21, wherein said method further comprises associating said special symbols in said group with each other.

26. The gaming method of claim 25, wherein said associating step comprises providing said special symbols that comprise at least one or more of game symbols that are visually the same, have a common element, share a common enhancing effect on the outcome of the game, and have an additional function in said game.

27. The gaming method of claim 26, wherein said associating step comprises associating an image associated with, or providing a representation of, said special symbols in said group.

28. The gaming method of claim 26, wherein said associating step comprises associating an image associated with, or providing a representation of, said group.

29. The gaming method of claim 26, wherein said associating step comprises providing said additional function that acts as at least one of a scatter symbol, trigger symbol, substitute symbol and jackpot symbol.

30. The gaming method of claim 21, wherein said group determining step comprises causing at least two special symbols of said group to form part of at least one of said predetermined winning combinations of game symbols.

31. The gaming method of claim 21, wherein said group determining step comprises causing at least two special symbols of said group to form part of at least two of said predetermined winning combinations of game symbols.

32. The gaming method of claim 21, further comprising the step of making X between 25 and 10,000, inclusive.

33. The gaming method of claim 21, wherein said group determining step comprises causing the appearance of said group such that S is at least one of:
(a) S=R;
(b) 6<S<R;
(c) 9<S<R;
(d) 12<S<R;
(e) S=R−1;
(f) S=R−2;
(g) S=R−3;
(h) S>9 when R>15;
(i) S>0.5×R;
(j) S≧0.6×R;
(k) S≧0.7×R;
(l) S≧0.8×R, and
(m) S≧0.9×R.

34. The gaming method of claim 21, wherein said group determining step further comprises causing special symbols to appear in at least ten to fifteen predetermined game positions adjacent each other starting from the leftmost side of said array.

35. The gaming method of claim 21, wherein said group determining step further comprises causing special symbols to appear in at least ten to fifteen predetermined game positions adjacent each other starting from the rightmost side of said array.

36. The gaming method of claim 21, wherein said group determining step further comprises causing special symbols to appear in at least the predetermined games positions to the left of a centre line of said array.

37. The gaming method of claim 21, wherein said group determining step further comprises causing special symbols to appear in at least the predetermined games positions to the right of a centre line of said array.

38. The gaming method of claim 21, wherein said game comprises a base game and a feature game, said method further comprising triggering said feature game in response to a trigger event in said base game, providing a sequence of plays of said feature game and guaranteeing at least one of S=R and S>0.5×R for at least one of said plays that is played during said sequence for each feature game triggered by said trigger event.

39. The gaming method of claim 21, wherein said method further comprises providing a plurality of additional arrays of game symbols arranged in predetermined game positions on said display and restricting R to the available predetermined game positions of said array and excluding the predetermined game positions of said additional arrays.

40. A computer system comprising a central processing unit configured for communication with an electronic gaming machine, wherein said computer system is configured to perform the method of claim 21.

41. A computer program configured to perform the method of claim 21.

42. A non-transitive carrier medium carrying computer executable code that, when executed on a central processing unit configured for communication with an electronic gaming machine, causes said central processing unit to perform the method of claim 21.
